(19) United States
(12) Patent Application Publication
(10) Pub. No.: US 2020/0015081 A1
(43) Pub. Date: Jan. 9, 2020

(54) METHOD FOR SECURE TRANSMISSION OF CRYPTOGRAPHIC DATA

(71) Applicant: IDEMIA FRANCE, Courbevoie (FR)

(72) Inventor: Cyril PORTERET, Courbevoie (FR)

(21) Appl. No.: 16/506,678

(22) Filed: Jul. 9, 2019

(30) Foreign Application Priority Data
Jul. 9, 2018 (FR) 1856278

(51) Int. Cl. H04W 12/04; H04L 9/30; H04L 9/08; G06K 7/14

(52) U.S. Cl. CPC H04W 12/04071; H04L 9/30; G06K 7/1413; G06K 7/1417; H04L 9/0866

(57) ABSTRACT

The invention relates to a method for secure transmission of data between two computer devices, a first device comprising sending means of an analog signal and a second device comprising acquisition means of the analog signal, the method comprising steps, performed by the first device, of:
generation of a first analog signal representative of a first cryptographic datum comprising an encryption key,
sending of the first analog signal via the sending means included in the first device, to the acquisition means included in the second device,
receipt of a second cryptographic datum from the second device, said second datum being at least partly encrypted by means of the encryption key,
processing of said second cryptographic datum as a function of the first cryptographic datum, comprising decryption of said second datum.

### TECHNICAL FIELD OF THE INVENTION AND PRIOR ART

The present invention relates to offline transmission of cryptographic data, in a context of exchange of secure data between computer devices.

This invention has advantageous applications for secure authentication of a user, or for encryption of sensitive data.

A variety of situations needs secure exchange of cryptographic data between a verifier device (considered as reliable, and potentially provided with access to confidential data) and a client device, such as for example the authentication of an individual, or the control an individual has valid electronic status letting him use a service. Other examples are encrypted transmission of biometric data acquired by a biometric sensor, the sensor having to be authenticated previously.

In particular, some known cryptographic algorithms are based on sharing a first cryptographic datum between the verifier device and the client device, necessary in advance so that both devices can then execute the operations which constitute the algorithm cryptographic.

In a context of secure authentication, “challenge-response” algorithms are known where the verifier device initially shares a challenge with the client device. The challenge can be a random number generated by means of a random number generator embedded in the verifier device. The client device returns a datum calculated from the random number and a secret key, which confirms the knowledge by the client device of the secret key, but does not reveal said secret key. Therefore, even if this datum is intercepted, it is very difficult for an attacker to discover the secret key. Sharing of the challenge by the verifier device for the client device still needs a communications channel to be set up between the two devices, typically via a wireless network connection: Internet, 3G, 4G, NFC (“Near-Field Communication”), Bluetooth network. This makes the challenge-response algorithm poorly adapted for authentication in a context where the network connection is not available.

Also, in the previous example it can be easier for an attacker to compromise the secret key which authenticates the client device, if at the same time it has intercepted the transmission of the random number and the transmission of the datum calculated from said random number.

### General Presentation of the Invention

There is therefore a need for a method for secure transmission of cryptographic data, such as a random number or a public key, between a verifier device and a client device, wherein the communications channel set up between the two devices for transmission needs no network connection.

There is also a need for a communications channel between the two devices which is very resistant to outside attacks.

A transmission method is preferably needed which is simple and rapid to execute, without any particular assumption on the level of security of the client device which can be a smartphone. Ubiquitous means of telephones, such as a screen or a photographic unit, must suffice to implementing the transmission method on the client side.

The invention responds to these needs by providing, according to a first aspect, a secure offline transmission method of data according to claim 1.

The method of the invention provides a highly satisfactory level of security in comparison with known methods, since the first cryptographic datum is transmitted in the form of an analog signal. An attacker should be physically near the client device to intercept the first cryptographic datum, which would make him easily recognisable.

An added advantage of the method of the invention is that transmission of the first cryptographic datum can be completed in the absence of any network connection between the verifier device and the client device.

Another advantage is to allow sending by the second device of an encrypted datum for the first device, without the two devices having exchanged keys, for example a public key/private key pair, prior to transmission.

Additional and non-limiting characteristics of a method for transmission of data of the invention are the following, taken singly or in any of their technically possible combinations:
the method comprises a preliminary step of receipt of a wake-up signal from the second device;
the step (a) comprises the generation, by the processor of the first device, of the first cryptographic datum;
the first cryptographic datum comprises a nonce;
the first device also has a secret key, the processing step (d) comprising determination of a third cryptographic datum from the first cryptographic datum and the secret key, and verification that the second cryptographic datum corresponds to said third cryptographic datum, to verify that the second device has the secret key.

A method presenting this latter characteristic is particularly advantageous used in a context of secure authentication, since the first cryptographic datum (which can be a nonce) is communicated simply via the analog signal, and the second cryptographic datum (determined for example from the nonce and the secret key) does not reveal the secret key. The level of security for the secret key is therefore very satisfactory;
the encryption key is a public key associated with a private key, with decryption of the second cryptographic datum being executed by the first device by means of the private key.
the second cryptographic datum is a message, said message comprising encryption of a secret by means of the public key, the processing step (d) comprising decryption of said secret.

A method presenting this latter characteristic is advantageously used for encryption of secure data of a message comprising a secret;
receipt (c) of the second cryptographic datum comprises reading, by acquisition means of the analog signal included in the first device, of a second analog signal representative of the second cryptographic datum, said second analog signal being transmitted by sending means of the analog signal included in the second device.

This characteristic is particularly advantageous since at the same time the first cryptographic datum and the second cryptographic are sent via analog signals, further heightening security;
the first analog signal is a first light signal,
   the sending means of an analog signal of the first device being a display unit, and the acquisition means of the analog signal of the second device being an imager, said light signal being acquired by an imager of the first device,
   the first light signal can be a “Quick Response” or “QR Code”, or a steganography, or a barcode;
the first device and the second device are mobile devices, preferably smartphones
the receipt of the second cryptographic datum comprises reading of a second light signal representative of the second cryptographic datum, said light signal being sent by a display unit of the second device,
   the second light signal can also be a code of one of these types;
the first analog signal is an audio signal,
   the sending means of an analog signal of the first device being an electroacoustic transducer, and the acquisition means of the analog signal of the second device being a microphone;
the second analog signal is an audio signal,
   the sending means of an analog signal of the second device being an electroacoustic transducer, and the acquisition means of the analog signal of the first device being a microphone;
the imager of the second device is located on a front face of the second device, said imager being preferably a photographic unit in autoportrait mode, the steps of the method being executed while the imager of the second device is facing the display unit of the first device;
the method comprises an intermediate reading step, by acquisition means of an analog signal of the first device, of a fourth cryptographic datum included in a control signal transmitted by sending means of the analog signal of the second device, and a later comparison step between the fourth cryptographic datum and the first cryptographic datum previously sent, to verify the integrity of the transmission of the first cryptographic datum;
the method is executed in the absence of a network connection between the first device and the second device.

According to a second aspect, the invention relates to a verifier device according to claim 11.

Such a device of the invention can also comprise the following additional characteristics:
the verifier device also comprises an imager device, preferably a photographic unit in autoportrait mode;
the analog signal sending means comprise a display screen;
the verifier device is a smartphone.

According to a third aspect the aim of the invention is a system comprising a verifier device such as defined previously, and a client device, said client device comprising a processor, a memory and acquisition means of an analog signal, the processor being configured to obtain from the first analog signal the first cryptographic datum comprising the encryption key, and being configured also to generate and transmit to the first device a second cryptographic datum at least partly encrypted by means of the encryption key.

Such a system can especially comprise as client device a smartphone.

Such a system can be utilised for executing a method according to the invention such as defined previously.

According to a fourth aspect and a fifth aspect, the invention relates respectively to a computer program product comprising code instructions for execution of a method for secure transmission of data such as defined hereinabove, and storage means readable by computer, on which are pre-recorded code instructions for execution of such a method.

### GENERAL PRESENTATION OF FIGURES

Other characteristics, aims and advantages of the invention will emerge from the following description which is purely illustrative and non-limiting, accompanied by the appended drawings, in which:

FIG. 1 is a schematic view of a system which can execute a method according to the invention;

FIG. 2 illustrates the steps of a method according to a first embodiment, in the context of a challenge-response algorithm of “Challenge-Handshake Authentication Protocol” or CHAP type;

FIG. 3 illustrates the steps of a method according to a second embodiment, in a context of RSA message encryption.

### DETAILED DESCRIPTION OF PARTICULAR EMBODIMENTS

The following examples relate to application of a method for transmission of cryptographic data for issues of authentication and/or data encryption. It will be clear that the invention could however be applied, with the same advantages, to any context requiring secure transmission of a cryptographic datum by a verifier device, in light of later processing events between said verifier device and a client device.

“Cryptographic datum” means a datum which can be handled by a processor, and which occurs in a cryptographic algorithm. Examples of cryptographic algorithms are algorithms of signature, message encryption, data hashing, authentication, etc.

Hereinbelow, similar elements of the attached figures will be designated by the same reference sign.

### Example of Architecture of Verifier-Client System

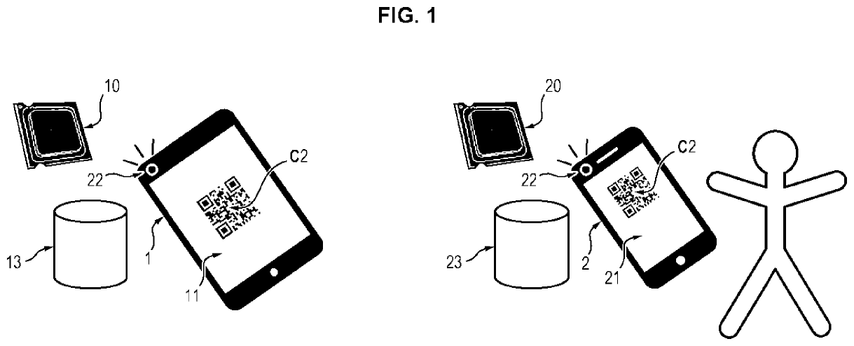

In reference to FIG. 1, a system adapted for transmission of secure data comprises a verifier device 1, and a client device, or again a user device, designated by the reference 2.

“Verifier device” means a device attached to a control authority. It can act as a device used by an individual authorized to execute control, or else an autonomous device. Advantageously, the verifier device can have access to data for controlling the identity of individuals, or controlling their belonging to a group (for example, the group of people having access authorisation to a zone).

“User device” means a device held by an individual who does not belong to a control authority, for example a smartphone or a tablet.

The verifier device 1 can be a mobile device, such a smartphone, having access or no access to the Internet network, or again a portable tablet. As an alternative, the verifier device 1 can be a fixed device such as a terminal.

The device 1 comprises means for processing data 10, for example a processor, and data storage means 13, such as a live memory or a dead memory.

The device 1 also importantly comprises means 11 for sending an analog signal, for example a display screen, a flash, a vibrator, an electroacoustic transducer (such as a loudspeaker).

“Analog signal” means a signal with continuous variation which corresponds to a physical phenomenon, which is not a digital signal, and coding for information. Typical examples of analog signals are light signals (preferably in visible light), or vibratory signals (preferably acoustic, i.e. audio signals). In other terms, the device 1 is capable of sending a physical signal which is perceptible by other devices, without there necessarily being transmission of digital data. The analog signal codes information by temporal or spatial modulation of a physical magnitude of the signal, intensity or frequency for example.

Optionally, the device 1 also comprises means 12 for acquisition of an analog signal, which correspond for example to the same type of analog signals as those which can be sent by the sending means 11, for example an imager device (such as a camera or an embedded photographic unit), a microphone, accelerometers.

In memory or in a remote database the verifier device 1 has access to data for executing cryptographic processings, for example linking information between users and secret authentication keys of said users, and/or message encryption keys.

The device 2 comprises data processing means 20, such as a processor, and data storage means 23, such as a live memory or a dead memory, and means 22 for acquisition of an analog signal. Optionally, the device 2 also has means 21 for sending an analog signal.

It is understood that advantageously during execution of a method which will be described later, the devices 1 and 2 are not connected, i.e. no network connection is set up between them.

Hereinbelow, examples will be cited where the analog signals that the devices 1 and 2 are likely respectively to be sent and acquired are light signals. More particularly, the means 11 correspond to a display screen which is configured to display “Quick Response” codes designated hereinbelow as QR Codes, such as the QR Code C1 of the figure. The means 22 correspond to a photographic unit located on the front face of the client device 2, configured to take a photograph of a QR Code displayed by the verifier device 1. However the skilled person can transpose the invention to other sorts of analog signals, for example audio signals in particular of DTMF (“dual-tone multi-frequency”) type commonly called Vocal Frequencies.

In the example of FIG. 1, the client device 2 also has a display screen 21 configured to display QR Codes such as the code C2, and the verifier device has a photographic unit 12 located on its front face. The two photographic units 12 and 22 can function in autoportrait mode, also called “selfie mode” so that the means 11 and 22 on the one hand and 12 and 21 on the other hand face each other simultaneously for easy interactive exchange of visual signals.

### Case of Secure Transmission of Nonce, to Execute Secure Authentication of the Client

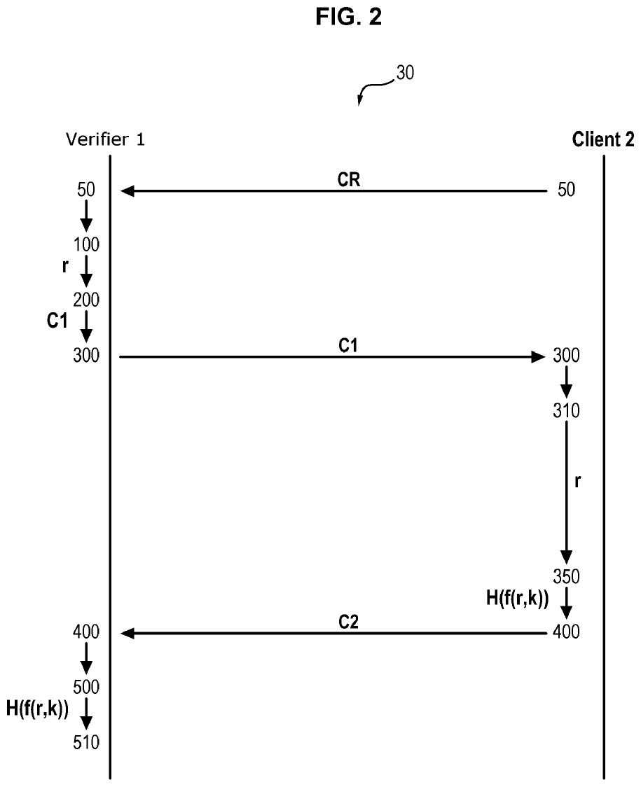

FIG. 2 schematically illustrates steps of an authentication method 30 of the client device 2 with the verifier device 1. Authentication is done here according to a protocol of CHAP type, for “Challenge-Handshake Authentication Protocol”.

The principle, well known to the skilled person, of this authentication method of challenge-response type is the following. The verifier device 1 and the client device 2 first share a datum r called “nonce” (i.e. an arbitrary number, that is, a single-use random number, from the English “number used once”). Using such an arbitrary number considerably reinforces the security of the method, since a different value and random nonce is used for each authentication, making attacks by replay difficult.

Also, the verifier device 1 knows a private key k which must not be sent in clear text, and is to verify the knowledge by the client device 2 of this private key k.

During the CHAP protocol, the client device 2 applies a predetermined cryptographic function f to the nonce and to the private key, then calculates a hash (also called “cryptographic print”) of the result given by this function f. The verifier device 1 for its part applies the same function f to the nonce and to the private key, then calculates the hash by means of the same hashing function. Authentication by the CHAP protocol of the client device 2 is considered as successful when the hash value returned by the client device 2 and the hash value calculated independently by the verifier device 1 are equal.

Here, an individual who holds the client device 2 wants to authenticate with the verifier device 1, to prove that he has previously bought an electronic ticket which is contained in the memory of the device 2. For example, the individual wants to go to a concert hall and has to prove to a guard who has the verifier device 1 that he is an authentic ticket buyer. It is understood that a concert hall is typically a place where it can be difficult to acquire a mobile network of 3G type, and “offline” authentication is of major interest.

For this purpose, the authentication method 30 comprises the following steps.

At an optional step 50, the client device 2 sends the verifier device 1 a wake-up signal CR. This signal can be transmitted in digital or analog form. The device 2 sends an authentication request to the verifier device 1. This step can be omitted, for example if the verifier device 1 is at the initiative of authentication.

### Transmission of the Nonce by Analog Signal

A first step (a) advantageously comprises generation 100 of the nonce r by the verifier device 1. The device 1 can for example comprise a random number generator for this purpose. This nonce r serves as basis for later calculations.

Next, during step (a), the verifier device 1 importantly carries out generation 200, from the nonce r, of a first analog signal noted C1. In the present example, the analog signal C1 is a visual code in the form of QR Code. Alternatively, the code C1 could be a visual code wherein the value of the nonce r is dissimulated by steganography, or else a barcode such as an EAN (“Electronic Article Number”) code.

The analog signal C1 can more generally take the form of any physical signal perceptible by a sensor of the client device 2 when the device 2 is placed at a short distance from the verifier device 1. The signal C1 can especially be an audio signal generated as a function of the value of the nonce r.

At a step (b), the verifier device 1 executes transmission 300 of the analog signal C1 to the client device 2, by means of the sending means 11, here a display unit. The processor 20 of the device 2 then calculates, at a step 310, the value of the first cryptographic datum, here the nonce r, from the first analog signal, here the visual code C1.

The steps (a) and (b) can be executed consecutively (the device 1 calculates the QR Code C1 and displays it immediately), or the QR Code C1 can be saved in memory on completion of step (a) and displayed later. It is possible at this stage to ensure that a control signal, for example a QR Code, is transmitted by the client device 2. One function of the control signal is to allow verification by the devices 1 and 2 that the first cryptographic datum, here the nonce r, has been sent correctly on completion of steps 200 and 300. If the result of this verification is positive, the verifier device 1 can send client device 2 an “OK” confirmation signal for the authentication method 30 to continue.

Authentication of the Client Device from the Value of the Nonce

The method 30 continues via a step (c) during which the client device 2 performs a calculation 350 of a second cryptographic datum D necessary for its authentication.

Since the client device 2 has the value of the nonce r, it can calculate the second cryptographic datum D. In the present example, the client device 2 applies any cryptographic function f inputting both the nonce r and the private key k whereof the method 30 controls the knowledge by the device 2. The function f was previously shared between the devices 1 and 2. For example, the function f can be a simple addition, in which case f(r,k)=r+k. If appropriate, the function f can be a more complex function for reinforcing the level of security of the algorithm. Next, the client device 2 calculates the hash of f(r,k) by means of the hashing function H also shared between the devices 1 and 2. In the present example, this is D=H(f(r,k)).

The client device 2 then executes transmission 400 to the verifier device 1 of the second cryptographic datum D, this datum D here being the hash H(f(r,k)).

Transmission of the second cryptographic datum D can be done by means of a second analog signal C2 representative of the value H(f(r,k)) (sent by sending means 21 of the device 2, and acquired by acquisition means 12 of an analog signal). As an alternative, the second cryptographic datum D can be sent by standard means, for example via an Internet, Bluetooth or NFC network connection.

To verify the validity of the authentication on the device 1 side, the device 1 itself should calculate the expected value for the second cryptographic datum, here the value H(f(r,k)), as a function of the value of the private key k and by means of the functions H and f.

In this respect, the verifier device 1 performs a step (d) for cryptographic processing, here in light of authentication, comprising generation 500 of a third cryptographic datum which corresponds to the expected value of H(f(r,k)).

It should be noted that the step 500 could be executed prior to the step 350, or at the same time as the step 350.

The device 1 then performs verification 510 that there is identity between the expected value of H(f(r,k)) and the value received from the client device 2 during the step (c).

If this verification is positive, the client device 2 has proved that it knows the key k and the holder of the device 2 is validly authenticated.

The method 30 has many advantages.

To intercept transmission of the nonce, an attacker should acquire an image of the QR Code; or preferably this image is not sent over a communications network. The security of the transmission is therefore improved.

Also, the method 30 does not require a connection to be set up between the verifier device 1 and the client device 2, such as an NFC, Bluetooth, Internet, 4G connection, etc. The method 30 has the added advantage of utilizing very widely used tools of smartphones: a photographic unit, a screen, a processor. The method 30 is therefore easy to use, even in environments where the network coverage is not uniformly good, such as concert halls or underground transport systems.

According to an alternative embodiment of the method 30, authentication of the client device 2 could be carried out by executing a digital signature algorithm of DSA type (“Digital Signature Algorithm”), during transmission of a message M.

In this context, the signature DSA not only authenticates the client device 2, but also proves the integrity of the message M.

Advantageously, the message M is a message which can be transmitted clearly, but whereof it is important to ascertain that it has not been falsified. The message M can for example be an identity document of a user of the client device 2.

The method according to this alternative example comprises transmission, jointly with the message M, of a DSA signature couple (s1, s2) whereof the values depend on a hash H(M), of the nonce r and of the private key k the knowledge is to be verified by the client device 2. The calculation of the signature DSA is known and is not detailed here.

If the verifier device 1, which for its part performs the calculation of the couple (s1, s2) obtains values similar to those received with the message M on the part of the client device 2, then the client device 2 is validly authenticated.

### Case of Secure Transmission of Encryption Key RSA

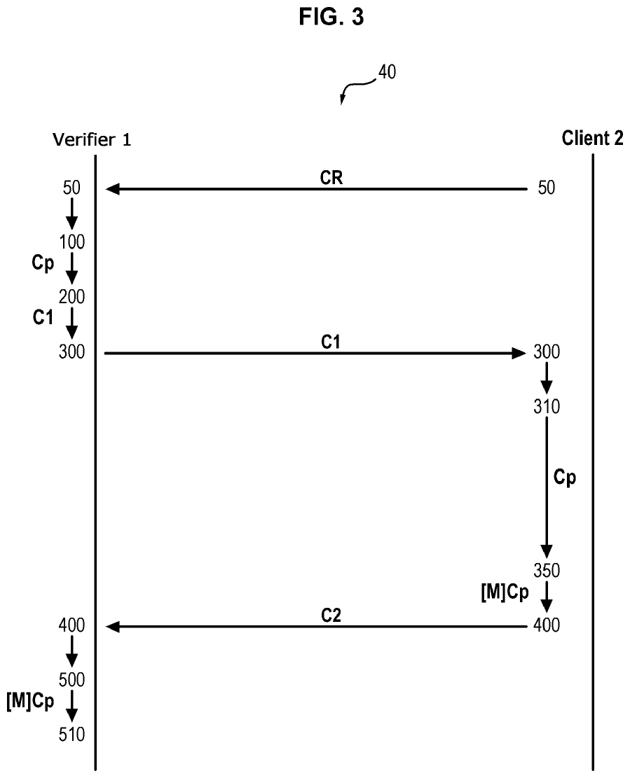

FIG. 3 schematically illustrates steps of a method 40 for communication of a message M which the client device 2 wants to transmit securely to the verifier device 1.

The method 40 comprises the execution between the devices 1 and 2 of an asymmetrical cryptography algorithm, typically an encryption algorithm RSA (for “Rivest, Shamir, Adelman”). The RSA algorithm is well known to the skilled person and will not be described in detail here. The verifier device 1 has a private decryption key Ck, associated with a public encryption key Cp, the private key Ck decrypting the messages encrypted by means of the public key Cp. The public key Cp and the private key Ck are constructed such that it is very difficult for an attacker to discover the value of the private key Ck from the value of the public key Cp.

The method for secure transmission of data of the invention has advantageous application for transmission of the public key Cp between the devices 1 and 2.

The method 40 comprises the following steps. The variants of the steps of the method 30 described hereinabove in relation to FIG. 2 apply also to the corresponding steps of the method 40.

In an optional step 50, the client device 2 sends a wake-up signal CR to the device 1 to initiate transmission of the public key.

Next, a step (a) advantageously comprises the generation 100 by the verifier device 1 of a private key Ck and a public key Cp, according to the algorithm RSA.

The public key Cp constitutes a first cryptographic datum which the device 1 has to transmit securely.

It is evident that it is not necessary for the two devices 1 and 2 to have exchanged keys, for example a public key/private key pair, prior to transmission.

The step (a) comprises the generation 200, by the device 1, of a QR Code C1 from the value of the public key Cp. A subsequent step (b) comprises the displaying 300 of said QR Code C1 by means of the display unit 11. As an alternative, the key generated at the step 200 and sent to the step 300 is a symmetrical encryption key.

At step 310, the client device 2 recovers from the QR Code C1 taken as photograph the value of the public key Cp and records this value in the memory 23. Optionally, a control signal is exchanged to verify the integrity of the transmission.

If any verification proves positive, at step 350′ the client device 2 performs the encryption of a message M containing a secret, by means of the public key Cp. The message M can have sensitive content, or may contain confidential data such as biometric data of individuals, or identity documents. On note [M]Cp the message M encrypted by means of the public key Cp sent previously. This message encrypted [M]Cp constitutes the second cryptographic datum.

A step (c) comprises the transmission 400 of this encrypted message [M]Cp, for example in the form of QR Code, or via a network connection. In a step (d), the device 1 executes cryptographic processings 500′ on the encrypted message M. In the present example, the device 1 decrypts the datum [M]Cp by means of the private key Ck it has.

1. A method for secure offline transmission of data between a first computer device (1) and a second computer device (2), the first device (1) comprising sending means of an analog signal (11) and the second device (2) comprising acquisition means of the analog signal (22), the method comprising the performing by a processor (10) of the first device (1) of steps of:
a) generation (200) of a first analog signal (C1) representative of a first cryptographic datum, the first cryptographic datum comprising an encryption key (Cp),
b) sending (300) of the first analog signal (C1) via the sending means of an analog signal (11) of the first device (1), to the acquisition means of the analog signal (22) of the second device (2),
c) receipt (400) of a second cryptographic datum (D) from the second device (2), the second cryptographic datum (D) being at least partly encrypted by means of the encryption key (Cp),
d) processing of said second cryptographic datum (D) as a function of the first cryptographic datum, said processing comprising decryption of the second cryptographic datum (D).

2. The method according to claim 1, wherein the step (a) comprises the generation (100), by the processor (10) of the first device (1), of the first cryptographic datum.

3. The method according to claim 1 or 2, wherein the second cryptographic datum (D) is a message, said message comprising a secret encrypted by means of the encryption key (Cp), the processing step (d) comprising the decryption (500′) of said secret.

4. The method according to any one of claims 1 to 3, wherein the encryption key (Cp) is a public key associated with a private key (Ck), the decryption of the second cryptographic datum being executed by the first device (1) by means of the private key (Ck).

5. The method according to any one of claims 1 to 4, wherein the first device (1) and the second device (2) are mobile devices, preferably smartphones.

6. The method according to any one of claims 1 to 5, wherein the receipt (400) of the second cryptographic datum (D) comprises the reading, by acquisition means (12) of an analog signal included in the first device (1), of a second analog signal (C2) representative of the second cryptographic datum (D), said second analog signal being transmitted by sending means (21) of the analog signal included in the second device (2).

7. The method according to any one of claims 1 to 6, wherein the first analog signal (C1) is a first light signal, preferably a code “QR Code”, or a steganography, or a barcode,
the sending means (11) of an analog signal of the first device (1) being a display unit, and the acquisition means (22) of the analog signal of the second device (2) being an imager.

8. The method according to claim 7, wherein the imager (22) of the second device is located on a front face of the second device (2), said imager (22) being preferably a photographic unit in autoportrait mode, the steps of the method for secure transmission of data being executed while the imager (22) of the second device is facing the display unit (11) of the first device.

9. The method according to any one of claims 1 to 6, wherein the first analog signal (C1) is an audio signal,
the sending means (11) of an analog signal of the first device (1) being an electroacoustic transducer, and the acquisition means (22) of the analog signal of the second device (2) being a microphone.

10. The method according to any one of claims 1 to 9, the steps of the method being performed in the absence of a network connection between the first device (1) and the second device (2).

11. A verifier device (1) comprising a processor (10), a memory (13) and sending means (11) of an analog signal,
the processor (10) being configured to generate a first analog signal (C1) from a first cryptographic datum comprising an encryption key (Cp) and being configured to execute a method for secure transmission of data according to any one of claims 1 to 10.

12. The device according to claim 11, said device (1) also comprising an imager device (12), preferably a photographic unit in autoportrait mode.

13. A system comprising a verifier device (1) according to any one of claim 11 or 12, and a client device (2),
the client device (2) comprising a processor (20), a memory (23) and acquisition means (22) of an analog signal,
the processor (20) being configured to obtain from the first analog signal (C1) the first cryptographic datum comprising the encryption key, and being configured also to generate and transmit to the verifier device (1) a second cryptographic datum (D) at least partly encrypted by means of the encryption key.

14. A computer program product comprising code instructions for executing a method for secure transmission of data according to any one of claims 1 to 10, when said code instructions are executed by a processor.

15. Storage means readable by computer, on which are pre-recorded code instructions for executing a method for secure transmission of data according to any one of claims 1 to 10.
